(19) United States
(12) Patent Application Publication
(10) Pub. No.: US 2016/0375605 A1
(43) Pub. Date: Dec. 29, 2016

(54) CHOPSTICK MAKING JIG AND SYSTEM

(71) Applicant: John J. Economaki, Lake Oswego, OR (US)

(72) Inventor: John J. Economaki, Lake Oswego, OR (US)

(21) Appl. No.: 15/192,913

(22) Filed: Jun. 24, 2016

Related U.S. Application Data
(60) Provisional application No. 62/185,411, filed on Jun. 26, 2015.

(51) Int. Cl. B27G 17/02; B27M 3/24

(52) U.S. Cl. CPC B27G 17/025; B27M 3/24

(57) ABSTRACT

A jig for making chopsticks defines a guideway for a cutting tool and includes a workpiece holder that is configured to support a stick thereon in at least two different positions inclined at different angles relative to the guideway when the jig is in use. The jig may form part of a system for making chopsticks including a cutting tool that is manually slid along the guideway to cut the stick. The jig enables the stick to be positioned in several different positions sequentially so that in each of the different positions the cutting tool cuts a different surface of the stick to thereby form a high quality chopstick by hand. The jig may be reconfigurable for different styles of chopsticks, and may include a blade sharpening feature and an optional end-trimming assembly for cutting a pyramidal finial on an end of the chopstick.

### RELATED APPLICATIONS

This application claims the benefit of U.S. Provisional Application No. 62/185,411, filed Jun. 26, 2015, which is incorporated herein by reference.

### TECHNICAL FIELD

The field of the present disclosure relates to hand tools and to systems and devices for shaping wood and, in particular, to a jig and cutting tool for making chopsticks.

### SUMMARY

A jig for making chopsticks includes an elongate body having a guideway extending along the length of the body, and a workpiece holder longitudinally aligned with the guideway. The workpiece holder is configured to support a stick on the workpiece holder in at least two different positions inclined at different angles relative to the guideway when the jig is in use.

A system for making chopsticks using such a jig includes a cutting tool that is manually slid along the guideway to cut the stick when the system is in use. When the system is in use, the stick is positioned on the workpiece holder by the user in several different positions sequentially so that in each of the different positions the cutting tool cuts a different surface of the stick to thereby form a high quality chopstick by hand.

Additional aspects and advantages will be apparent from the following detailed description of preferred embodiments, which proceeds with reference to the accompanying drawings.

### BRIEF DESCRIPTION OF THE DRAWINGS

FIG. 1 is an isometric view of a jig for a chopstick making system;

FIG. 2 is a top plan view of the jig of FIG. 1 together with a hand plane cutting tool of a chopstick making system, and wedge blocks of the system securing a stick on the jig;

FIG. 3 is an isometric view of the chopstick making system of FIG. 2 with the hand plane slidably supported on a guideway of the jig, and with the stick and wedge blocks omitted;

FIG. 4 is a pictorial oblique side view showing a workpiece holder arm of the jig of FIG. 3 rotated to a setup position, and side skids of the hand plane seated in gage slots in the jig for setting the depth of the skids relative to a body of the hand plane;

FIG. 5 is a cross-section view of the chopstick making system of FIG. 3;

FIG. 6 is an isometric view of the jig of FIG. 1 fitted with a saw blade and a slide table that is shown supporting a chopstick during an end-trimming operation;

FIG. 7 is a top plan view of the jig and chopstick of FIG. 6;

FIG. 8 is an end view of the jig and chopstick of FIG. 6; and

FIG. 9 is an bottom isometric view showing a honing surface along the bottom of the jig of FIG. 1, together with a honing guide holding a blade of the hand plane of FIG. 2 during a sharpening operation.

FIG. 10 is a trimeric view of a jig for a chopstick making system according to another embodiment.

FIG. 11 is a cross-section view of the jig of FIG. 10.

FIG. 12 is a partially exploded perspective view of a cutting tool according to some embodiments.

### DETAILED DESCRIPTION OF PREFERRED EMBODIMENTS

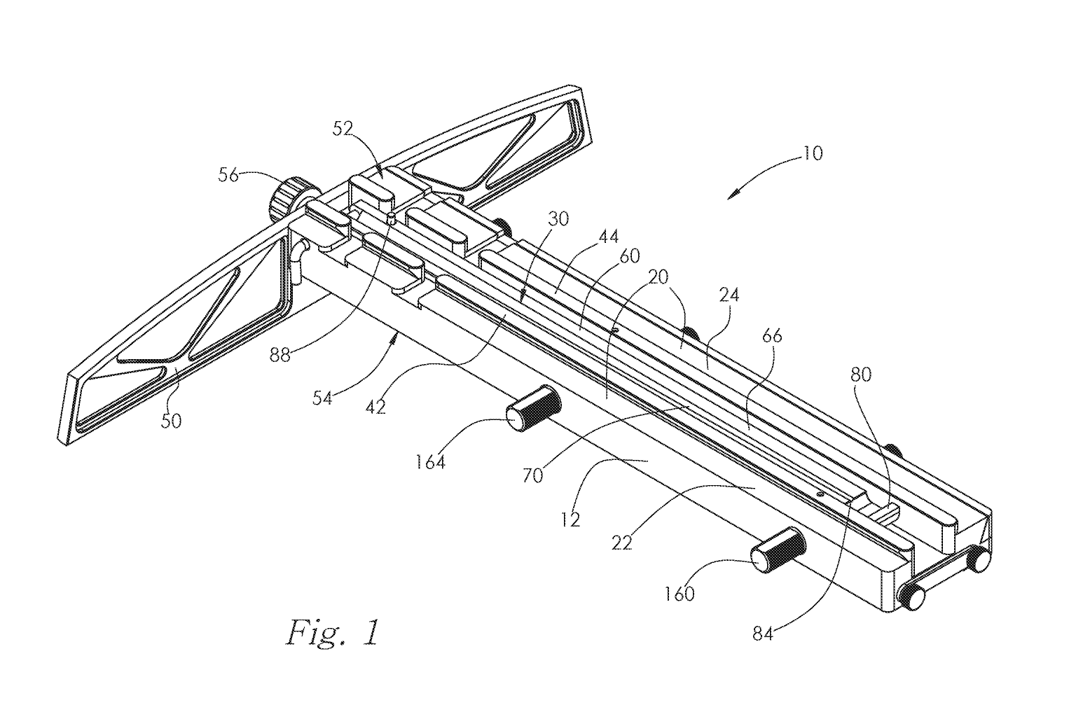

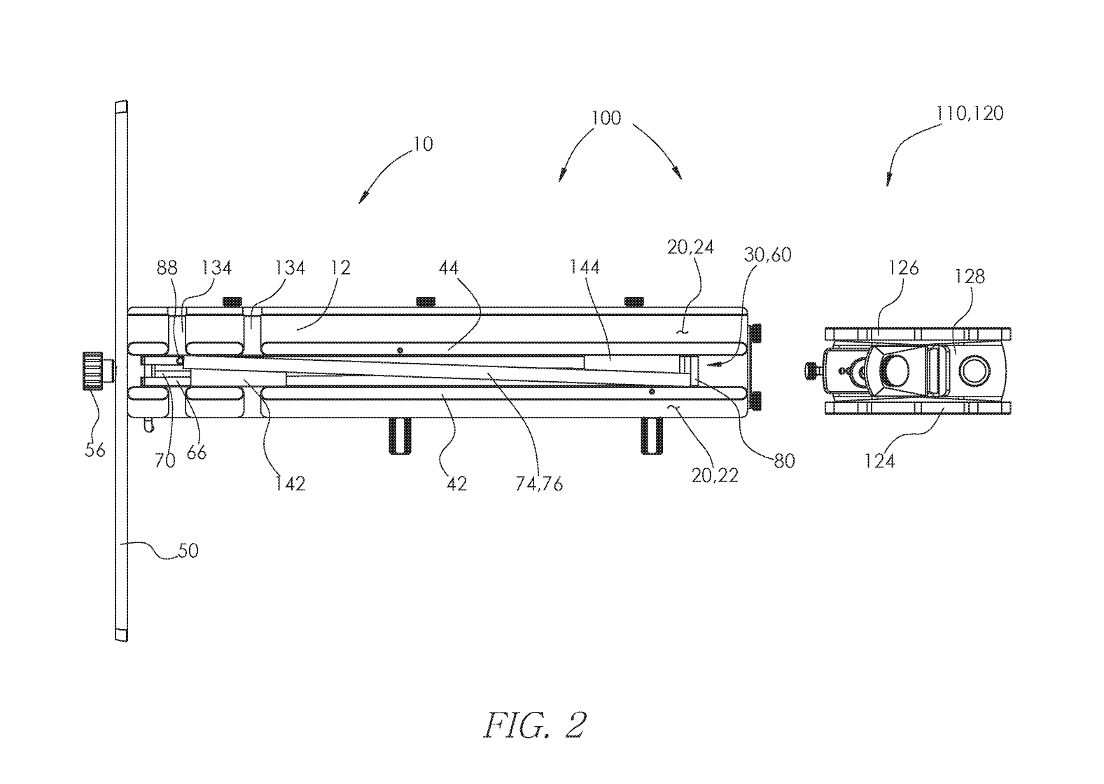

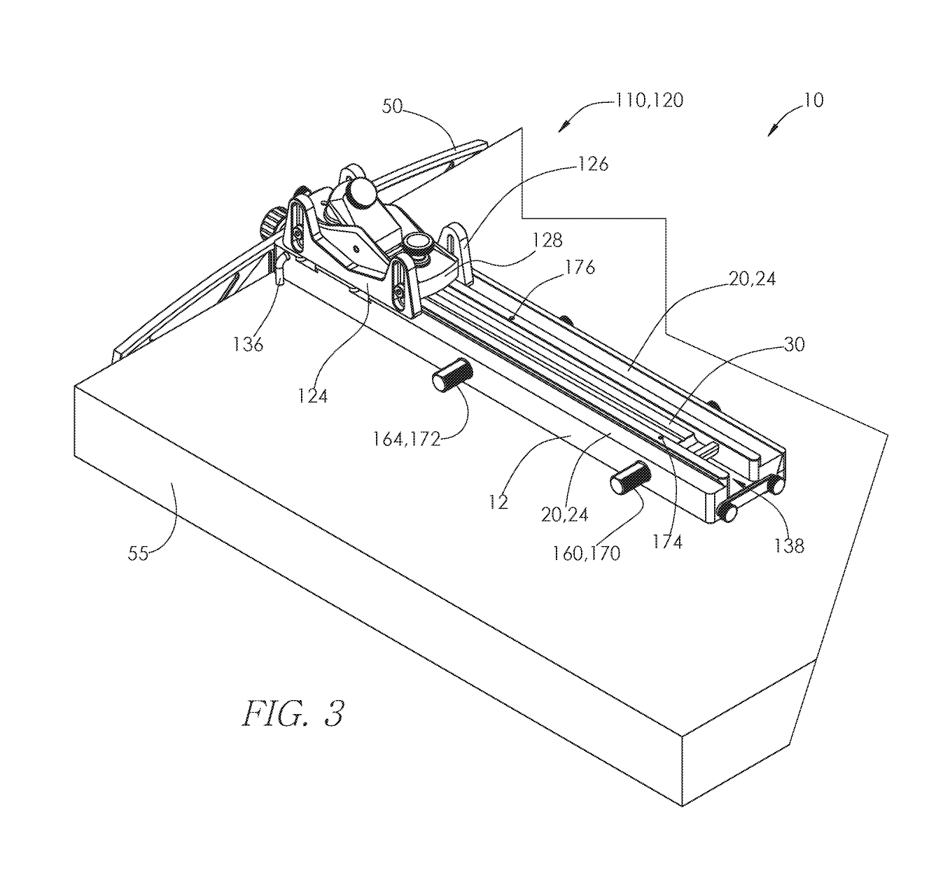

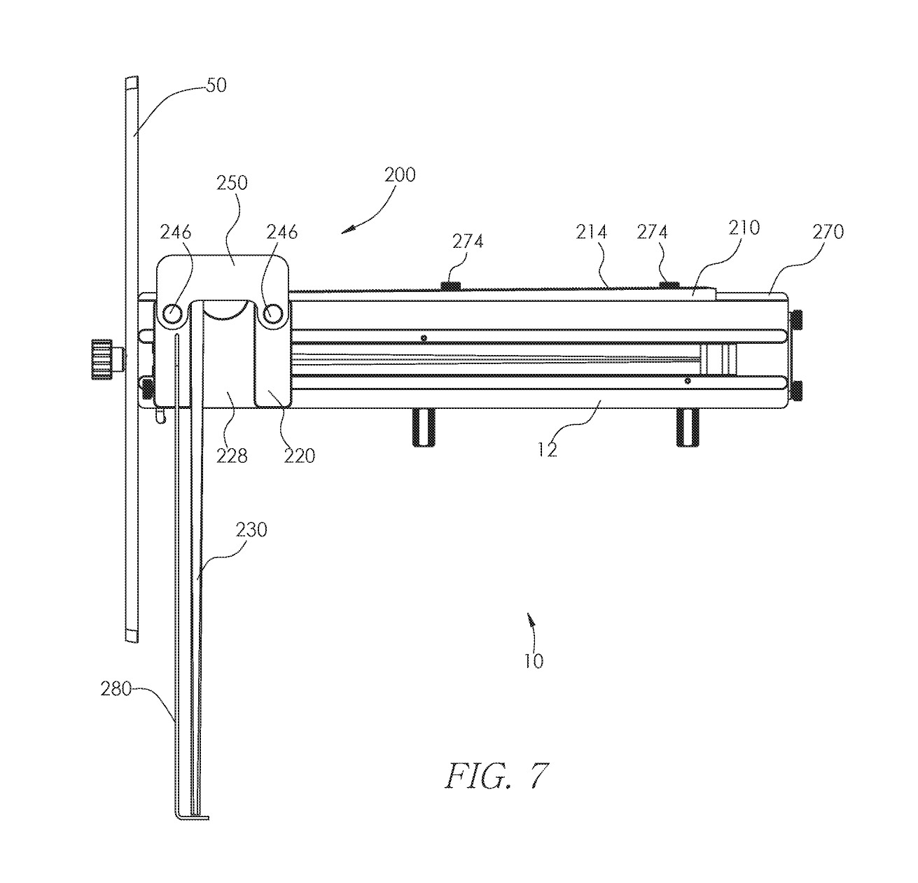

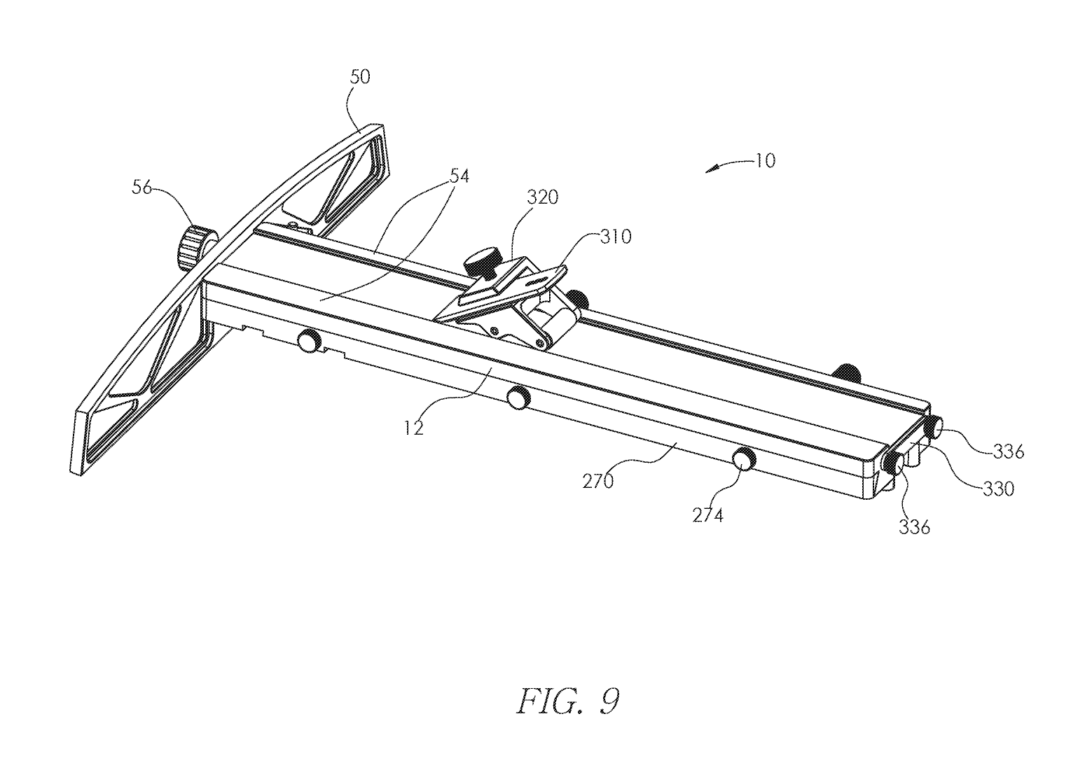

FIG. 1 illustrates a jig 10 for making chopsticks according to an embodiment of the present disclosure. Jig 10 forms part of a chopstick making system 100 shown in FIGS. 2-9 in various configurations and modes of operation and described in detail below. With reference to FIG. 1, jig 10 includes an elongate body 12 having a guideway 20 extending along the length of the body 12. Guideway 20 comprises two spaced-apart parallel flat tracks 22, 24 along which a cutting tool 110 (FIG. 2) rides when the chopstick making system 100 is in use to establish a fixed cutting plane, as further described below with reference to FIGS. 2-4. Between the tracks 22, 24 and aligned longitudinally with guideway 20 is a workpiece holder 30 flanked by first and second rails 42, 44 that serve as lateral sidewalls or fences for workpiece holder 30. A head stock 50 is attached to a head end 52 of body 12 and extends downwardly below a base surface 54 of body 12 so that head stock 50 can hook and rest against an edge of a work surface 55 (FIG. 3), such as a table, workbench, or other work surface on which jig 10 is supported when in use. Head stock 50 is attached to body 12 by a lock knob 56, screw, or other fastener, which is preferably releasable to allow head stock 50 to be repositioned on head end 52 when jig 10 is used for sharpening, as described below with reference to FIG. 9.

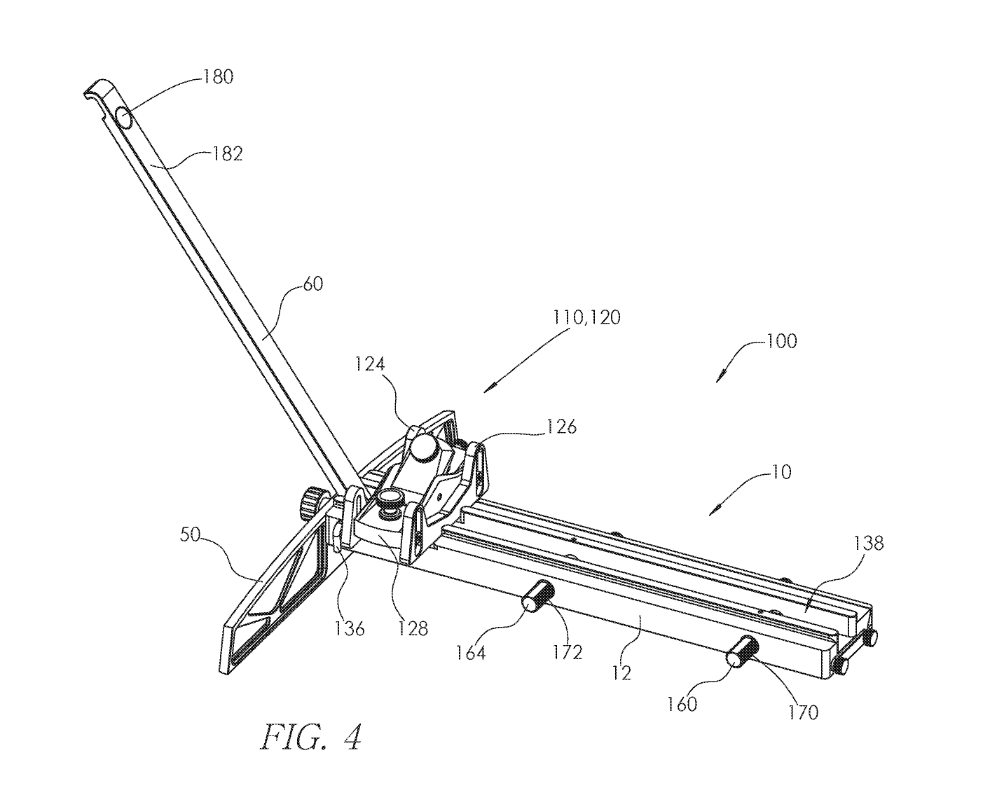

Workpiece holder 30 includes a workpiece supporting arm 60 having a generally planar upper surface forming a bed 66 in which a groove 70 is formed. Arm 60 is pivotably mounted to body 12 as further described below with reference to FIG. 4. In the embodiment illustrated, groove 70 is a V-shaped groove (V-groove). However, in other embodiments, groove 70 may comprise other shapes. Groove may have side surfaces that are curved or inclined and may have a bottom that is sharp (as in a V-groove) or another shape. Groove 70 preferably has flat side surfaces inclined 45 degrees relative to the planar surface of bed 66, as in a V-groove, so that groove 70 can support a stick 74—such as a chopstick blank 76 (FIG. 2) having a square cross-section—at a 45-degree angle relative to bed 66 and relative to the fixed cutting plane of cutting tool 110. Groove 70 is also preferably inclined along its length, as described below.

A stop 80 is located proximate a distal end 84 of groove 70. Stick 74 rests against stop 80 when system 100 is in use to thereby inhibit stick 74 from sliding off workpiece holder 30 when cutting tool 110 is moved along guideway 20 in the direction away from head end 52 and toward distal end 84 to cut and shape the stick. The groove 70 is preferably inclined relative to bed 66 so as to increase in depth along the length of guideway 20 in the direction away from distal end 84 and toward head end 52. In the embodiment illustrated, stop 80 is formed at the end of workpiece holder arm 60, but could be formed in other portions of jig—the important thing being the position of stop 80 relative to workpiece holder 30 and groove 70. A second stop 88 projects above bed 66 of workpiece holder 30 near head end 52 to allow the direction of cutting tool 110 to be reversed, for example in the event the grain of the wood in stick 74 is reversed.

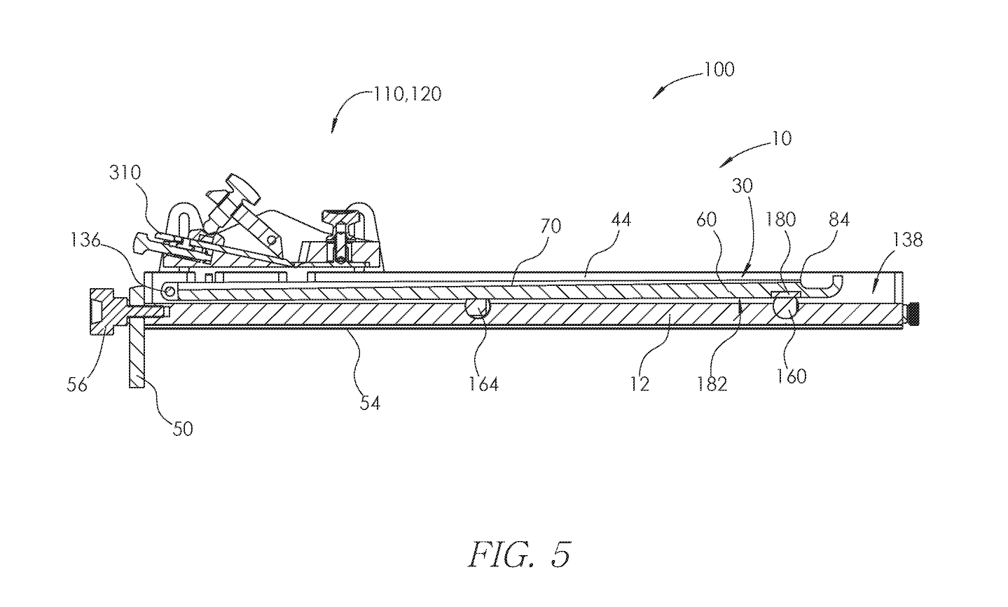

FIG. 2 is a top view of chopstick making system 100 including a cutting tool 110 and jig 10, shown holding a stick 74 (chopstick blank 76) which is shaped into a chopstick through the use of cutting tool 110, as described below. In the embodiment illustrated, cutting tool 110 is a hand plane 120, such as model HP-8™ miniature block plane offered by Bridge City Tool Works® with adjustable depth skids 124, 126 mounted to the sides of a body 128 of plane 120. Skids 124, 126 ride along respective first and second tracks 22, 24 of guideway 20 during a planing operation as illustrated in FIG. 3. The height (depth) of each of the skids 124, 126 of plane 120 is adjustable relative to body 128 of plane 120. A pair of depth gage slots 134 are provided in body 12 of jig 10 for setting the depth of skids 124, 126 relative to body 128, as illustrated in FIG. 4 and further described below with reference to FIG. 4. Skids 124, 126 restrict the depth of cut made by plane 120 as it shapes stick 74 into a chopstick. Skids 124, 126 ride against tracks 22, 24 as the maximum cutting depth is reached, to thereby establish a fixed cutting plane of chopstick making system 100 spaced slightly above rails 42, 44. The inner sides of skids 124, 126 also cooperate with outside faces of respective first and second rails 42, 44 to capture the plane 120 on guideway 20 and to guide the plane 120 along a generally linear working path. Rails 42, 44 extend along and above guideway 20 and on opposite sides of workpiece holder 30. Rails 42, 44 are preferably spaced apart wider than the width of stick 74 and approximately the same distance as the width of a blade of cutting tool 110, such as a cutting iron 310 (FIG. 5) of plane 120.

FIG. 3 shows plane 120 with skids 124, 126 riding on guideway 20, but omits stick 74 of FIG. 2. In FIG. 3, jig 10 is resting on a table 55 so that head stock 50 abuts an edge of table 55 and prevents jig 10 from sliding on the surface of table 55 when cutting tool 110 is used to shape stick 74 by planing in a direction away from the edge of table 55.

With reference to FIG. 4, arm 60 of workpiece holder 30 is pivotable about a pivot pin 136 inserted through holes in body 12 and arm 60 to pivotably retain arm 60 to body 12. Pivot pin 136 is removable to allow arm 60 to be replaced with arms having different shapes and differently sized grooves for making the different styles of chopsticks preferred in different countries and regions. Arm 60 is pivotable from its normal planing position (shown in FIG. 3), wherein the workpiece mounting arm 60 is seated in a channel 138 formed between rails 42, 44, to an adjustment position illustrated in FIG. 4, wherein arm 60 is pivoted out of channel 138 and away from rails 42, 44. In the adjustment position, skids 124, 126 can be seated in depth gage slots 134 (FIG. 2) and adjusted relative to body 128 of plane 120 to establish the depth setting of plane 120. Depth skids are adjusted by loosening four screws that affix skids 124, 126 to body 128 of plane 120, allowing the sole of the plane's body 128 to rest on the tops of rails 42, 44 between gage slots 134 and the skids 124, 126 to come to rest on the bottoms of gage slots 134. The four screws are then tightened to fix the position of the skids 124, 126 relative to body 128.

Turning back to FIG. 2, stick 74, in the form of a chopstick blank 76, is shown supported on bed 66 of workpiece holder 30 in a first position. A preferred chopstick blank 76 is made of wood having a square initial shape 7 mm by 7 mm and a length of approximately 270 mm. Stick 74 may alternatively be a different shape or size, may initially be rough or round, and/or may be made of a material other than wood, such as bamboo, for example. A pair of wedge blocks 142, 144 may be inserted at opposite ends of and on opposite sides of chopstick blank 76 to wedge chopstick blank 76 in place on a diagonal across workpiece holder 30. First wedge block 142 is wedged between chopstick blank 76 and first rail 42 proximally of head end 52 of jig 10; and second wedge block 144 is wedged between chopstick blank 76 and second rail 44 near distal end 84. The pressure of wedge blocks 142, 144 holds chopstick blank 76 in a slightly bent or S-shaped configuration, which spans the entire width of workpiece holder 30. This position allows a greater portion of the width of the cutting edge of the iron 310 (FIG. 5) of plane 120 to be used when initially planing the flat sides of the square chopstick blank 76, which reduces wear on the cutting edge and reduces the need for sharpening.

FIG. 5 is a longitudinal cross section view of the chopstick making system 100 illustrated in FIG. 3. With reference to FIG. 5, arm 60 of workpiece holder 30 rests on first and second selector switches 160, 164 which consist of cylindrical shafts rotatably mounted in body 12 of jig 10 and extending into channel 138. The selector switches 160, 164 have knurled end knobs 170, 172 (FIG. 4), respectively, which protrude from body 12 and allow the selector switches 160, 164 to be manipulated to selectively change an angle of arm 60 relative to guideway 20 for inclining the stick 74 relative to guideway 20 and the cutting plane as further described below. First and second selector switches 160, 164 are retained in cylindrical bores in body 12 by respective first and second dog-point grub screws (set screws) (not shown) inserted into small threaded holes 174, 176 (FIG. 3), respectively, in rails 42, 44 or elsewhere in body 12. A central portion of each of the selector switches 160, 164 which extends across the channel 138 includes a series of flats (illustrated but not numbered in FIG. 5) which are angularly distributed about the shaft of each of the selector switches 160, 164 and spaced different radial distances from the axis of each shaft. Arm 60 is supported on the flats for planing operations. FIG. 5 illustrates selector switches 160, 164 and arm 60 in a first position.

Arm 60 may be selectively indexed and moved among two or more different angular positions about pivot pin 136 during different stages of the chopstick making operation by rotating the selector switches 160, 164, as explained below. Selector switches 160, 164, and particularly the central portions thereof with the flats, are essentially cams that establish a vertical support position for arm 60. Each selector switch 160, 164 has at least two different settings, and possibly three or four, which may allow a wider variety of different styles of chopsticks to be made, for example by changing workpiece holder 30 to a different size or style of arm 60. First selector switch 160 underlies arm 60 near distal end 84. Second selector switch 164 is spaced apart from first selector switch 160 and underlies arm 60 at approximately a midpoint between pivot pin 136 and first selector switch 160. Second selector switch 164 provides reinforcing support beneath arm 60 to thereby prevent the workpiece holder 30 from sagging during planing operations. A magnet 180 (best shown in FIG. 4) is affixed to arm 60 within a recess under a bottom side 182 of arm 60 and is magnetically attracted to first selector switch 160 to inhibit arm 60 from chattering or inadvertently lifting off of first selector switch 160 during a planing operation.

With reference to FIG. 5, a series of shaping operations for making a chopstick will now be described. Beginning with a square chopstick blank 76 approximately 7 mm×7 mm×270 mm, as previously described, the chopstick blank 76 has four faces, sequentially numbered face 1, face 2, face 3, and face 4. With first and second selector switches 160, 164 in a first position, chopstick blank 76 is wedged onto bed 66 of workpiece holder 30 with face 1 facing up and away from arm 60. Face 1 is then planed. The angle of inclination of arm 60 results in tapering of the chopstick blank. For a Chinese style chopstick, the angle of inclination of bed 66 is set at approximately 0.25 degrees relative to guideway 20, when selector switches 160, 164 are in the first position. Next, chopstick blank 76 is turned so that face 2 is facing up and away from arm 60, and re-wedged onto bed 66. Face 2 is then planed in the same manner as face 1.

After planing faces 1 and 2, selector switches 160, 164 are turned to a second position. For a Chinese style chopstick, the second position sets the angle of inclination of bed 66 at approximately 0.5 degrees relative to guideway 20. With selector switches 160, 164 in the second position, chopstick blank 76 is turned and wedged onto bed 66 with face 3 is facing up and away from arm 60, then planed. Next, chopstick blank 76 is turned with face 4 facing up and away from arm 60 and re-wedged onto bed 66, and face 4 is planed. At this point, the chopstick is tapered along its entire length. The angle of taper is set by a combination of the shape of arm 60 and bed 66, and the height settings of selector switches 160, 164. Arm 60 may be changed for different styles of chopsticks having different desired tapers. For example, Japanese style chopsticks have a more aggressive taper, requiring bed angles of 0.5 degrees and 0.85 degrees in the respective first and second positions, relative to guideway 20.

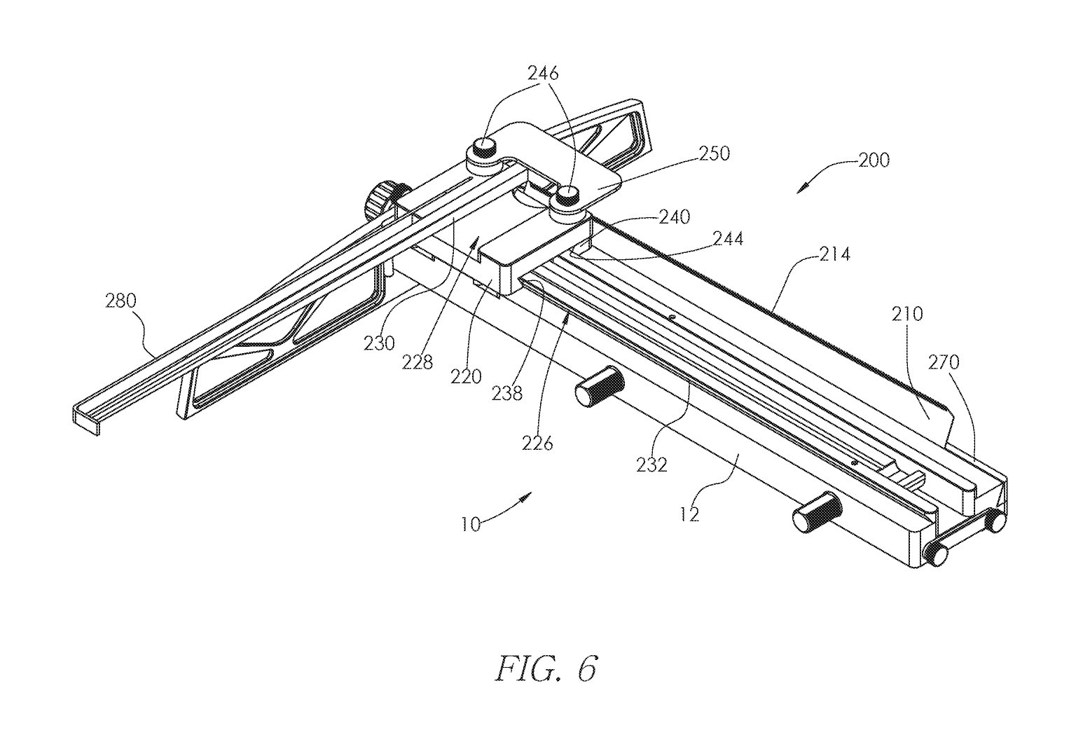

After planing the taper of faces 1, 2, 3, and 4, a portion of the four edges between the faces may be planed to result in a perfect octagonal shape at the small end of the chopstick. For example, for a Chinese-style chopstick, the tapered chopstick blank 76 is seated in groove 70 with a first edge facing outward while selector switches 160, 164 are in the second position. Because only about half or less of the chopstick lies above the cutting plane, planing each edge causes only the tip to be tapered to an octagon, leaving the edges near the wide end of the chopstick intact for proper seating in groove 70 for subsequent planing of the other 3 edges. At this point, the chopstick blank 76 has been positioned in 8 different positions for the 8 separate planing operations to form a nearly-finished chopstick. If desired, the edges may then be sanded by hand using fine sandpaper. The finishing touch is to cut a 4-sided pyramidal finial onto the wide end of the chopstick using an end-trimming assembly 200, including a saw attachment described below with reference to FIGS. 6-8.

One possible alternative configuration for a jig (not illustrated) is a block that has several different faces and rotates among several different rotational orientations relative to the head stock, with each face of the jig having a different channel or groove for holding the chopstick blank in the different orientations relative to a workbench surface and relative to guideways formed in the block. Such a configuration may reduce the complexity of the jig by eliminating the need for a movable arm, the selector switches, the magnet, the pivot pin, etc. Multiple guideways may be provided, with one or more located on each face. In one embodiment (not illustrated), the sole of the plane may ride directly against a guideway formed in the body of the jig. For example, the edges of the sole of the plane could ride directly on guideways stepped into the body of the jig, which would eliminate the need for depth skids and depth gage slots.

FIGS. 6, 7 and 8 are respective isometric, top, and distal end views of jig 10 with an optional end-trimming assembly 200 installed. With reference to FIGS. 6-8, end-trimming assembly 200 includes a saw blade 210 having an upwardly-facing working edge 214 and a slide table 220 slidably mounted to a table guideway 226 formed in body 12 of jig 10. Slide table 220 includes a pusher groove 228 within which is supported a nearly-finished chopstick 230 during the end-trimming operation, further described below. Table guideway 226 comprises a dovetail rail consisting of undercut first and second dovetail surfaces 232, 234 formed along the outer sides of rails 42, 44, respectively. Slide table 220 includes a fixed dovetail slot surface 238 (technically a half-dovetail slot) formed in an underside of slide table 220, which slides against first dovetail surface 232. Slide table 220 further includes an adjustable gib 240 having a movable dovetail slot surface 244 that slides against second dovetail surface 234 when slide table 220 is installed and in use. Gib 240 is attached to slide table 220 by a pair of thumbscrews 246, allowing convenient installation of slide table 220 and adjustment of gib 240 without tools. Slide table 220 and gib 240 are preferably formed of acetyl or another low-friction material to facilitate smooth sliding without lubrication. A cutting guard 250 is installed on top of slide table 220 and mounted using the same thumbscrews 246 as used to adjust gib 240.

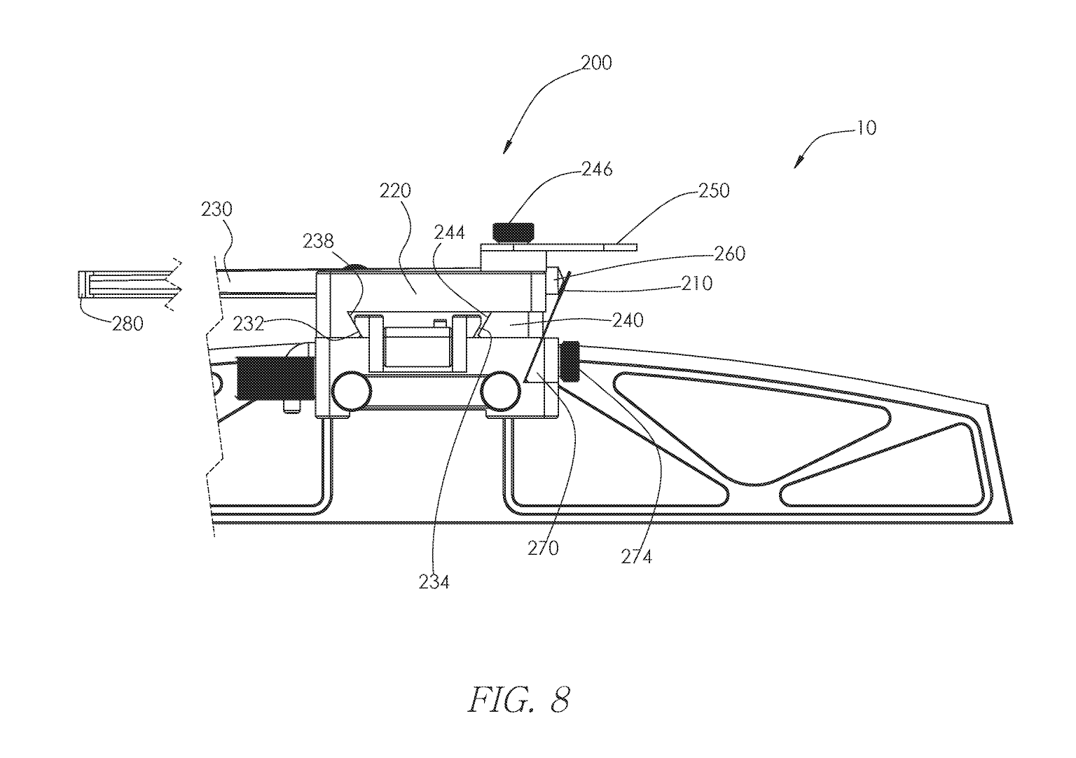

Saw blade 210 is mounted to body 12 and pitched at an angle of 22.5 degrees relative to vertical (or 67.5 degrees relative to the bottom of pusher groove 228) for cutting a pyramidal finial 260 (FIG. 8) on the end of chopstick 230. A blade retainer 270, including three thumbscrews 274, secures saw blade 210 to body 12 along the length of a base of saw blade 210. An adjustable length stop hook 280 is attached to slide table 220 for setting a position of chopstick 230 relative to saw blade 210. During an end-trimming operation, chopstick 230 is supported on slide table 220 and held in place by hand as the slide table 220 is moved along table guideway 226 so that chopstick 230 is passed along and against saw blade 210 to cut one of the faces of finial 260. The chopstick is repositioned with each of the four different major faces of chopstick 230 resting on pusher groove 228 to cut each face of the pyramidal finial 260. Different shaped finials, such as a single chamfer finial may also be cut using end-trimming assembly 200.

Skilled persons will appreciate that slide table 220 may be slidably mounted to jig 12 in another manner. For example, table guideway may comprise other than dovetail surfaces; or dovetail surfaces may be recessed or located in another place on body 12.

FIG. 9 illustrates an optional sharpening feature of jig 10. Turning now to FIG. 9, jig 10 is shown with body 12 rotated 180-degrees on head stock 50 so that base surface 54 of jig 10 faces upward and head stock 50 depends downwardly from rails 42, 44 (not shown) to hook onto a table or other work surface (not shown). In this sharpening position, a honing material such as a strip of extremely fine sandpaper 300, which is preferably recessed in a honing groove along base surface 54, is exposed for convenient sharpening the cutting edge of the iron 310 of hand plane 120 (FIGS. 3 and 5). Iron 310 is removed from hand plane 120 and clamped in a honing guide, such as two-roller honing guide 320, to pitch the iron 310 at a precise 30-degree angle relative to the surface of sandpaper 300 or other honing material during sharpening. Sandpaper 300 is secured within the honing groove by clamping a first end of sandpaper 300 between head stock 50 and body 12, and by clamping a second end of sandpaper 300 between a clamp bar 330 secured to a distal end of base 12 by a pair of thumbscrews 336.

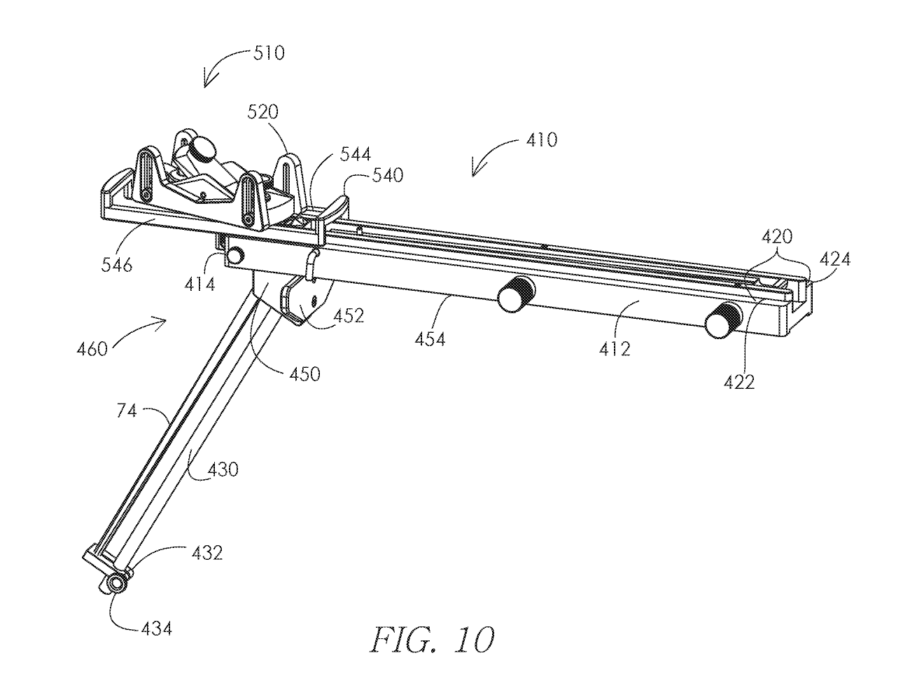

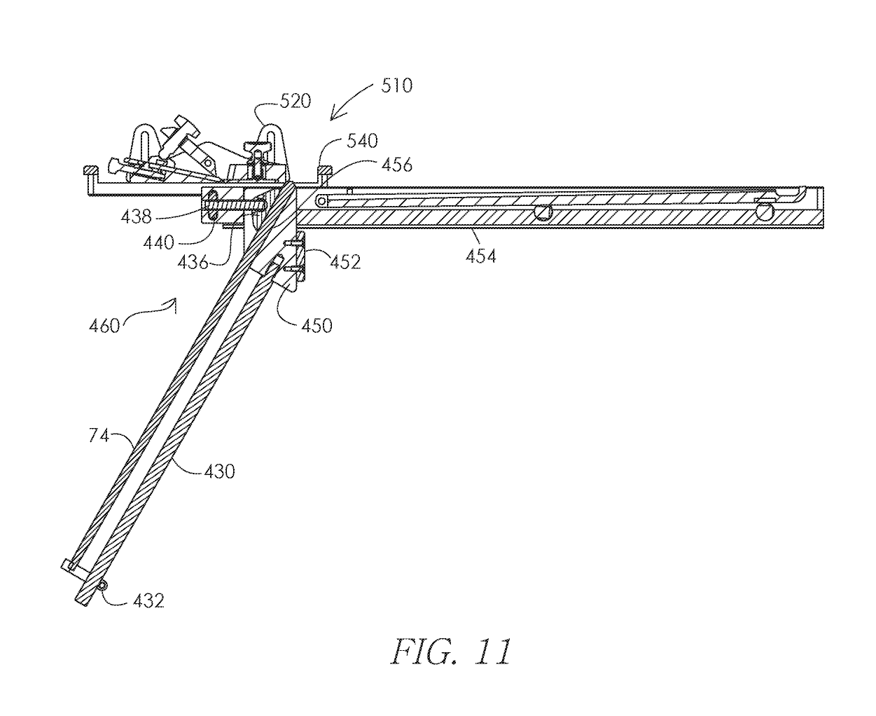

FIGS. 10 and 11 are respective trimetric and cross-sectional a jig 410 according to another embodiment with an end-trimming assembly 460 installed. The arrangement of jig 410 is similar to the arrangement of jig 10 discussed above. As such, like features are denoted with similar reference numerals plus 400.

Rather than a head stock 50, an alternative stock 450 is attached to a proximal end of elongate body 412 and extends downwardly below a base surface 454 of body 412. Stock 450 includes a stock plate 452 that abuts against a table, work bench, or other work surface 55 (FIG. 3) on which jig 450 is supported when in use. Stock 450 is wedged shaped and includes a support surface 456 so that stick 74 is supported at an angle relative to elongate body 412 during an end-trimming operation, as described below. The angle of support surface 456 is set to create the pyramid shape of the finial. Stock 450 is retained by and may be removed by thumb screw 414 for compact packaging of jig 410 and end-trimming assembly 460.

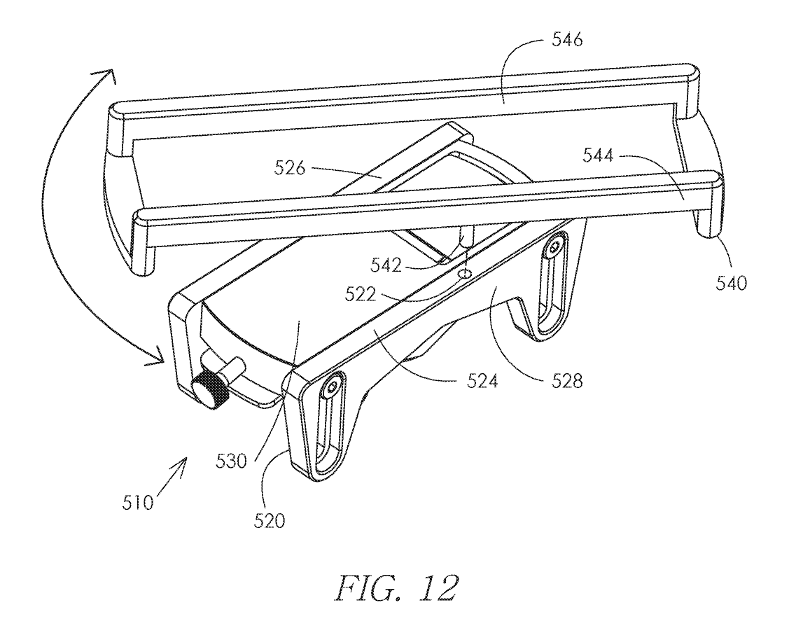

Attached to stock 450 is a support arm or bar 430 that carries a movable platform 432 that may be selectively positioned along bar 430 based on the length of the chopstick 74 and secured thereto with a screw 434. Support arm 430 is attached to stock 450 at the angle that stick 74 is supported on support surface 456 of stock 450. A clamping wedge 436 (FIG. 11) is positioned on a back end 416 of jig 410 to hold stick 74 in place during an end-trimming operation. Clamping wedge 436 is driven by a screw 438 that screws into a knurled nut 440 that is manually operated to tighten or loosen clamping wedge 436 to hold stick 74 in place during an end-trimming operation or to remove stick 74. Support arm 430 is angled relative to body 412 so that only a portion of the end of stick 74 is above a fixed cutting plane of jig 410. The angle of the support surface 456 and support arm 430 allows a cutting tool 510 (FIG. 12) to equally cut one side of a pyramid finial. Although FIGS. 10 and 11 illustrate a cutting tool 510, cutting tool 110 may also be used. After one side of the end of stick 74 has been trimmed, a user can loosen the clamping wedge 436 via screw 438 and rotate stick 74 to trim another side of the pyramid finial. And the steps are then repeated until all four sides of stick 74 have been trimmed.

FIG. 12 illustrates an alternative cutting tool 510 that may be used in any of the embodiments discussed above. Cutting tool 510 may be a hand plane 520, as illustrated in FIG. 12, mounted on a sled 540. Hand plane 520 includes skids 524, 526 mounted to the sides of a body 528 of plane 520. As illustrated in FIG. 12, skids 524, 526 are flush with a bottom 530 of body 528 of plane 520. At least one of skids 524, 526 includes a hole 522 to receive a pin 542 located on one of runners 544, 546 of sled 540. Although hole 522 is shown on skid 524 in FIG. 12, hole 522 may be located on either of skids 524, 526. Hand plane 520 is pivotably coupled about pin 542 for rotation of the cutting tool relative to sled 540 and elongate body 12 or 412 about an axis transverse to guideway 20 or guideway 420, respectively, to facilitate a comfortable and effective hand position and position of hand plane 520. Sled 540 includes runners 544, 546 that ride along respective first and second tracks 22, 24 of guideway 20 or first and second tracks 422, 424 of guideway 420 during a planing operation.

It will be obvious to those having skill in the art that many changes may be made to the details of the above-described embodiments without departing from the underlying principles of the invention. For example, while cutting tool 110 has been described herein as a hand plane 120 or block plane, other types of cutting tools may be suitable for use with jig 10. Also, the location of guideways 20 relative to workpiece holder 20 may be different in other embodiments, the important aspect being the location of the cutting plane relative to the bed 66 and the groove 70. The scope of the present invention should, therefore, be determined only by the following claims.

1. A jig for making chopsticks, comprising:
an elongate body having a guideway extending along the length of the body;
a workpiece holder longitudinally aligned with the guideway, the workpiece holder configured to support a stick on the workpiece holder in at least two different positions inclined at different angles relative to the guideway when the jig is in use.

2. The jig of claim 1, wherein the workpiece holder has an elongate groove formed therein.

3. The jig of claim 2, wherein the workpiece holder includes a generally planar upper surface in which the groove is formed, and the groove is a V-groove that is inclined relative to the upper surface to as to increase in depth along a length of the guideway.

4. The jig of claim 2, further comprising a stop proximate an end of the groove and against which the stick rests when the jig is in use to thereby inhibit the stick from sliding off the workpiece holder as a cutting tool moves along the guideway and shapes the stick.

5. The jig of claim 1, further comprising one or more wedge blocks sized to wedge between the stick and a portion of the jig to secure the stick against the workpiece holder.

6. The jig of claim 1, wherein the workpiece holder is selectively movable relative to the guideway for inclining the stick relative to the guideway.

7. The jig of claim 6, further comprising a selector switch that supports the workpiece holder and is manually actuated to selectively adjust an angle of the workpiece holder relative to the guideway.

8. The jig of claim 7, wherein the selector switch has at least two different settings.

9. The jig of claim 7, further comprising a second selector switch supporting the workpiece holder at a location spaced apart from the first selector switch, and wherein first and second selector switches can be manually set to change angle of inclination of the workpiece holder relative to the guideway.

10. The jig of claim 1, further comprising a saw blade securable to the jig and a slide table that is movably mountable on a table guideway of the jig for movement of the slide table along the saw blade when the saw blade is secured to the jig.

11. The jig of claim 10, wherein the table guideway comprises dovetail surfaces and the slide table includes a fixed dovetail slide surface that slides against one of the dovetail surfaces and an adjustable dovetail gib that slides against the other of the dovetail surfaces when the slide table is in use.

12. The jig of claim 11, wherein the table guideway is different from the guideway, the table guideway includes a pair of spaced-apart rails extending along and above the guideway and on opposite sides of the workpiece holder, the rails are spaced apart wider than the width of the stick, and wherein the dovetail surfaces are formed in the rails.

13. The jig of claim 1, further comprising a pair of spaced-apart depth gage slots for adjusting the depth of skids on a hand plane.

14. A system including the jig of claim 1, and further comprising a handheld cutting tool that is manually slid along the guideway to cut the stick when the system is in use.

15. The system of claim 14, wherein the cutting tool includes a hand plane with a bearing that rides against the guideway when the system is in use.

16. The system of claim 15, wherein the bearing comprises two adjustable skids, and the jig includes a pair of spaced-apart depth gage slots for setting the depth of the skids relative to a body of the hand plane.

17. The system of claim 14, wherein the cutting tool, when sliding along the guideway, establishes a cutting plane, and the workpiece holder is spaced apart from the cutting plane at an angle such that the cutting plane intersects at least a portion of the length of the stick when the stick is supported on the workpiece holder in either of the two different positions.

18. The system of claim 14, wherein the jig includes a pair of spaced-apart rails extending along and above the guideway and on opposite sides of the workpiece holder, the rails spaced apart wider than the width of the stick and approximately the same distance as the width of a blade of the cutting tool.

19. The system of claim 14, further comprising a sled coupled to the handheld cutting tool to guide sliding movement of the cutting tool along the guideway.

20. The system of claim 19, wherein the handheld cutting tool is pivotably coupled to the sled for rotation of the cutting tool relative to the sled and the body about an axis transverse to the guideway.

21. A system of claim 1, further comprising a finial cutting portion, the finial cutting portion including:
a stock wedge extending downwardly from the elongate body of the jig, the stock wedge configured to support the stick at an angle;
a support arm extending downwardly from the stock wedge;
a platform movable along the support arm, the platform including a portion to abut against a distal end of the stick; and
a clamping wedge to abut the stick opposite the stock wedge.
